(19) United States
(12) Patent Application Publication
(10) Pub. No.: US 2018/0331586 A1
(43) Pub. Date: Nov. 15, 2018

(54) WIRELESS POWERED SENSOR AND SENSOR SYSTEMS

(71) Applicant: Integrated Device Technology, Inc., San Jose, CA (US)

(72) Inventors: Jianbin HAO, San Jose, CA (US); Cheng-wen HSIAO, San Jose, CA (US)

(21) Appl. No.: 15/980,395

(22) Filed: May 15, 2018

Related U.S. Application Data
(60) Provisional application No. 62/506,434, filed on May 15, 2017.

(51) Int. Cl. H02J 50/80; H02J 7/02; H02J 50/10; H04B 5/00

(52) U.S. Cl. CPC H02J 50/80; H02J 7/025; H04B 5/0081; H04B 5/0031; H04B 5/0037; H02J 50/10

(57) ABSTRACT

A passive sensor unit that is powered wirelessly and communicates with a reader unit that powers the pass sensor unit is presented. In some embodiments, a passive sensor unit includes a sensor; a receive coil; a circuit coupled to the sensor, the circuit configured to receive sensor data from the sensor; and a wireless power circuit configured to receive power from the receive coil and configured to provide power to the circuit. The pass sensor unit is unpowered except proximate to the reader unit. A sensor system can include one or more passive sensor units, each of the one or more passive sensors configured to receive wireless power from a receiver coil and communicate data through the receiver coil; and one or more reader units, each of the one or more receiver units configured to supply power and communicate with a set of the one or more passive sensor units.

### RELATED APPLICATIONS

The present disclosure claims priority to U.S. Patent Ser. No. 62/506,434, filed on May 15, 2017, which is herein incorporated by reference in its entirety.

### TECHNICAL FIELD

Embodiments of the present invention are related to wireless powered sensors.

### DISCUSSION OF RELATED ART

Sensors for various uses are becoming common in everything from smart clothing to medical monitoring. Such sensors can be used for many purposes, including, for example, to monitor medical conditions such as activity trackers, heart rate, temperature, health conditions, blood alcohol levels, or other conditions. Similar sensors can also be used for monitoring environmental conditions such as temperature, fluid flow, light conditions, chemical compositions, or other conditions. However, current sensor technologies fall short of being fully compatible with daily use.

FIG. 1A, for example, illustrates a conventional sensor system 100, which may be a wearable sensor system or other type of sensor system, placed to monitor one or more conditions. As is illustrated in FIG. 1A, sensor system 100 includes a circuit board 102, a battery 104, and one or more sensors 108. These components are all enclosed in a sealed plastic container between a housing 106, a face 116, and a battery cover 114. Circuit board 102 includes circuits for operating sensor 108, collecting data, and communicating the data outside of sensor system 100. As is shown in FIG. 1A, circuit board 102 can be isolated from battery 104 with an isolation pad 112. Consequently, a sensor system 100 is formed by positioning a sensor 108 into housing 106 and positioning circuit board 102 to electrically contact sensor 108. A seal 110 may be placed around circuit board 102 and face 116. Face 116 can include, or be formed from, sensors 108. Sensors may also be included on circuit board 102. Face 116 can provide optical, thermal, or other access to sensors 108. Face 108 may also include a user interface, which may be a touch screen for receiving input and for displaying data. Isolation pad 112 is then inserted against circuit board 102 and battery 104 is placed such that electrical connections are made to supply power to circuit board 102. Battery cover 114 clips onto device 100 so that device 100 is a sealed wearable device.

FIG. 1B illustrates a block circuit diagram of device 100 as illustrated in FIG. 1A. As illustrated in FIG. 1B, battery 104 is coupled to provide power to circuitry 122, which resides on circuit board 102 as illustrated in FIG. 1A. Circuitry 122 is coupled to one or more sensors 108 and can include any circuitry, digital or analog, for driving sensors 108 and receiving data from sensors 108. For example, circuitry 122 may include one or more digital processors, analog-to-digital converters, memory for storing data and programming, or other circuitry. Circuitry 122 is also coupled to communications 124. Although communications 124 is illustrated as being coupled to a wireless antenna, communications 124 may also include a port for a hard-wire connection to a digital device. Circuitry 122, then, through communications 124, can provide data to a user. As illustrated in FIG. 1A, communications 124 may, for example, display data on a touch screen on face 116.

Although such a device can be embedded as wearables, it is difficult for the circuit board and the battery to be embedded with fabric or otherwise provided in a wet or otherwise adverse environment. Further, these devices tend to be uncomfortable, visually unattractive, and provide for waterproof and safety concerns, especially if battery 104 fails. Consequently, eventually devices such as device 100 become unusable. Furthermore, they are high cost devices. With much smaller lifetimes as the fabric in which they are embedded or the environment in which they are used is cleaned or otherwise maintained, or as is provided for other adverse environmental conditions where device 100 may be used, such devices can be very expensive to use.

Therefore, there is a need to develop better sensor technologies for wearable and other embeddable purposes or for sensors used in other environments.

### SUMMARY

In accordance with some embodiments of the present invention, a passive sensor unit that is powered wirelessly and communicates with a reader unit is presented. In some embodiments, a passive sensor unit includes a sensor; a receive coil; a circuit coupled to the sensor, the circuit configured to receive sensor data from the sensor; and a wireless power circuit configured to receive power from the receive coil and configured to provide power to the circuit, wherein the sensor unit is unpowered when power is absent from the receive coil.

A reader unit can include a power source; a transmit coil; a wireless power transmitter configured to receive power from the power source and configured to drive power to the transmit coil; a communications circuit coupled to the wireless power transmitter, the communications circuit coupled to the wireless power transmitter to transmit and receive data; and a processor coupled to the communications circuit, the processor coupled to send and receive data through the wireless power transmitter.

A sensor system can include one or more passive sensor units, each of the one or more passive sensors configured to receive wireless power from a receiver coil and communicate data through the receiver coil; and one or more reader units, each of the one or more receiver units configured to supply power and communicate with a set of the one or more passive sensor units.

These and other embodiments are further discussed below with respect to the following figures.

### BRIEF DESCRIPTION OF THE DRAWINGS

FIGS. 1A and 1B illustrate an example of a conventional sensor device.

FIG. 1C illustrate a block representation of a conventional sensor device.

FIG. 2A illustrates a sensor according to some embodiments of the present invention.

FIG. 2B illustrates a sensor reader according to some embodiments of the present invention.

FIGS. 2C and 2D further illustrate embodiments of a reader and sensor, respectively, according to the present invention.

FIG. 2E further illustrates separation of a conventional sensor into embodiments of a reader and a sensor according to some embodiments of the present invention.

FIGS. 3A through 3C illustrate a system with sensors according to some embodiments of the present invention.

FIG. 4 illustrates a wireless hub/sensor pair according to some embodiments of the present invention.

FIG. 5 illustrates interaction between a sensor and a wireless hub according to some embodiments of the present invention.

FIG. 6 further illustrates a sensor and a wireless hub according to some embodiments of the present invention.

FIG. 7 further illustrates a sensor according to some embodiments of the present invention.

FIG. 8 further illustrates a wireless hub according to some embodiments of the present invention.

FIG. 9 illustrates example sizes of a sensor and a wireless hub according to some embodiments.

FIG. 10 illustrates a sensor according to some embodiments.

FIG. 11 illustrates interaction between a sensor reader and a sensor according to some embodiments of the present invention.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description and the accompanying drawings that illustrate inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

Some embodiments of the present invention can provide sensors for wearable technologies, medical technologies, shipping technologies, construction technologies and other areas with an easily produced and inexpensive passive sensor in combination with a wireless hub. The passive sensor and wireless hub separate the power source and controller portion with the passive sensor including a wireless power receiver coil and the sensor while the wireless hub includes the power supply. The two components cooperate to provide power for sensing and communicate to receive the day. In this fashion, for example the wearable device has a low-cost sensor portion that can be embedded into the wearable device and clothing. The detachable power source and controller can be detached while the wearable device is under conditions of wash or replacement.

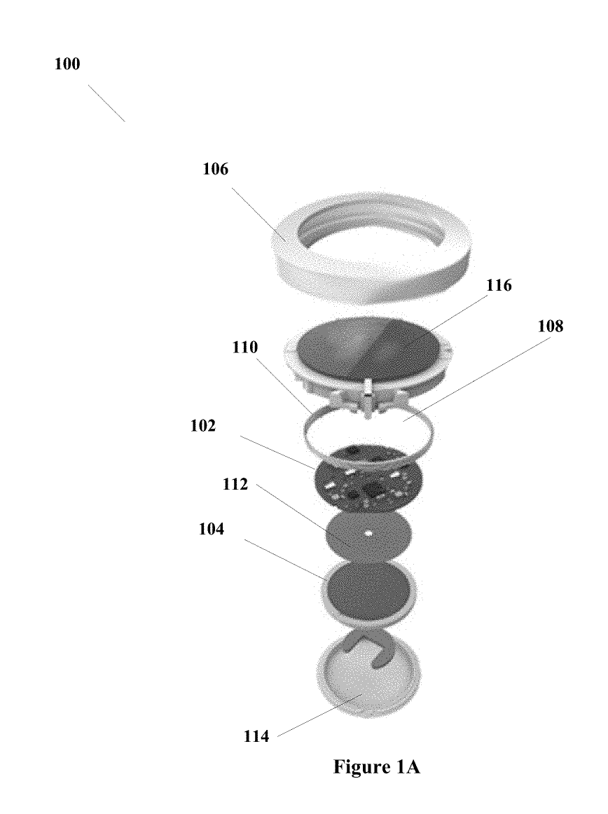

FIG. 1C illustrates a modular depiction of a conventional sensor system 100 as illustrated in FIGS. 1A and 1B. As is illustrated in FIG. 1C, a conventional sensor system 100 can include a sensor 108 (which can include on or more individual sensors), a power source 104, a communications or interface block 124 and circuitry 122 that receives and processes data from sensors in the sensor block 108 and provides data to the interface/communications block 124 for transmission to an end user.

Circuitry 122 can, for example, use an analog front end (AFE) 110 that receives, performs analog processing (e.g., filters, amplifiers, and other analog processing), and digitizes data received from sensor 108. The digitized data can be preprocessed by a digital signal processing (DSP) 112. A driver 114 can provide power and input signals to sensors in sensor block 108. Circuitry 122 can further include various power converters 150, power and temperature protection circuits 148, power regulation blocks 132, rectifier blocks 130, thermal control blocks 134, and status or power indicators 138. Furthermore, internal clocks 136 can also be included.

In addition, circuitry 122 can include a microcontroller 142 and memory 140. Microcontroller 142 can execute instructions for operating sensors 108, receiving data from sensors 108, storing sensor data, and providing sensor data to interfaces and communications 124. Microcontroller can execute instructions that are stored in memory 140.

Interfaces and communications 124 can include interfaces for communicating with an end user, either wired or wirelessly. As such, common interfaces include GPIO, I2C, or other interface methods.

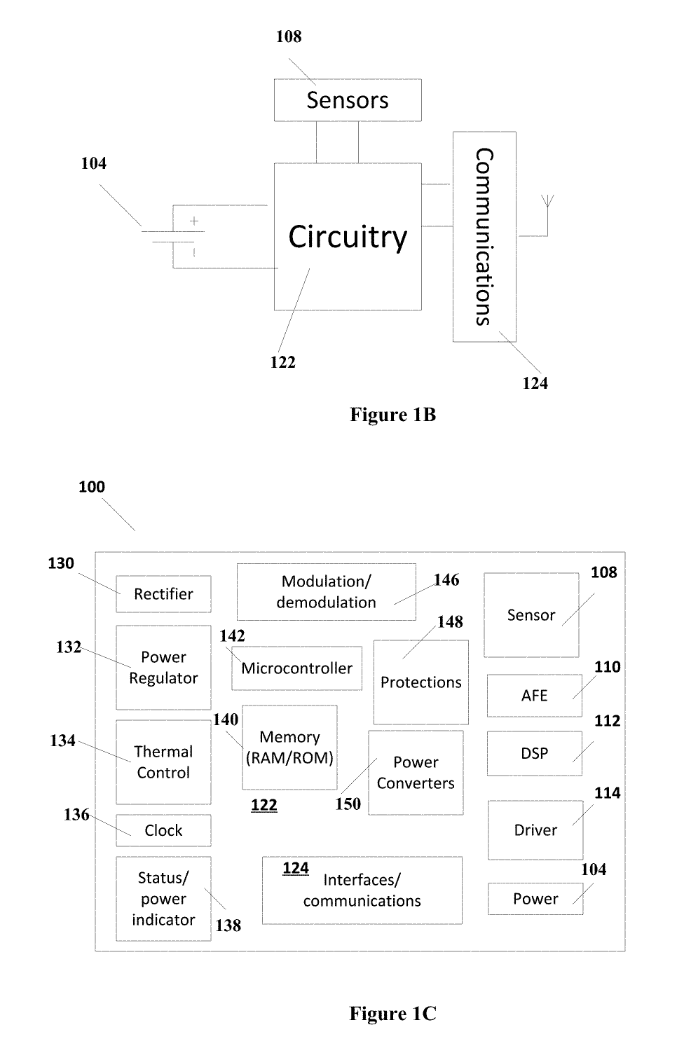

FIGS. 2A and 2B a reader unit 202 and a sensor unit 250 according to some embodiments of the present invention. Reader unit 202 and sensor unit 250 divide the functionality of a conventional sensor system 100 such that sensor unit 250 is passive, i.e. unpowered unless power by wireless power transfer from reader unit 202, and reader unit 202 includes internal or external power sources for powering both reader unit 202 and sensor unit 250. Reader unit 202 can represent a hand-held reader or a hub, each of which is further discussed below. Sensor unit 250 receives power wirelessly as transmitted between a transmit coil 204 and a receive coil 252. Furthermore, data can also be exchanged between reader unit 202 and sensor unit 250 through transmit coil 204 and receive coil 252.

As shown in FIG. 2A, reader unit 202 includes a power source 222 that, along with power converters 214, rectifiers 232, power regulators 230, and modulation/demodulation 216 provides power for reader unit 202 and supplies power through wireless transfer through transmit coil 204, driven by wireless power 206. Power source 222 may be an internal battery or external power source as the need dictates. Additionally, reader unit 202 may include a thermal control block 228 along with protections 212. Protection 212 may include, for example, over temperature protection (OTP), over voltage protection (OVP), over current protection (OCP), and under voltage protection (UVLO). Reader unit 202 also can include other circuitry, such as a clock 226 and status/power indicator monitoring blocks 224.

Reader unit 202 further includes a wireless power block 206 which, powered by power source 222, drives transmit coil 204. Wireless power block 206 include driver and switching technology to drive power into transmit coil 204. Any wireless power transfer system can work. For example, power may be transferred wirelessly using standards from the Wireless Power Consortium (WPC) or using standards from the Power Matters Alliance (PMA). Other methods of wirelessly transferring power may also be used.

A back-channel communications block 208 allows for communication of data through transmit coil 204 or through a magnetic secured data transmission through transmit coil 204 or a separate coil incorporated within transmit coil 204. The output power can be modulated, for example in frequency or amplitude, to transmit data and can be monitored to detect a modulation in the load to receive data. As such, communications block 208 can transmit instructions to and receive sensor data from a sensor 250 through the wireless power transfer. Any communication protocol can be implemented for communication of data between reader 202 and sensor 250.

Furthermore, reader 202 may include a user interface 234. User interface 234 may include interface devices such as, for example, displays for data presentation (e.g. screens or LED indicators), data input devices (e.g., keyboards, touchscreens, or other pressure or contact sensitive devices), and audio devices such as speakers. Any device and method for receiving instructions from and providing data to a user can be used.

Reader 202 may also include one or more interfaces in interface block 210. Such interfaces may include wireless and wired interfaces. For example, interface block 210 may include Bluetooth, low-energy Bluetooth (BLE), 6LoWPAN, ZigBee, near-field communication (NFC), or other wireless systems. Interface block 210 can also include wired interfaces such as, for example, I2C and GPIO systems, as well as other wireless data transmission systems can be used.

Further, reader 202 can include a microcontroller 218 coupled to memory 220 to control and operate reader 202. Memory 220 can be a combination of volatile (RAM) and non-volatile (ROM) memories which store programming that can be executed by microcontroller 218 as well as data. Microcontroller 218, executing instructions stored in memory 220, receives data through communications block 208, may provide processing for such data, and may store data in memory 220 and also supplies the data to UI 234. Microcontroller 218 may further supply data through interfaces 210, and may also receive updates to programming stored in memory 220 or perform other functions.

Sensor unit 250, as is illustrated in FIG. 2B, only includes the sensor components. Sensor 250 does not include an internal power and is completely dependent for power on the power transferred by wireless power transfer from reader 202. As illustrated in FIG. 2B, sensor 250 includes a sensor block 262, analog front end (AFE) 264, and driver 266 to drive sensors in sensor block 262 and receive signals from sensor in sensor block 262. As discussed above, AFE 264 includes all of the analog circuitry to receive, filter, amplifier, or otherwise process signals from sensors in sensor block 262 as well as digitizing that data. Driver 266 provides all of the power signals or other signals required for sensors in sensor block 262 to operate.

Power is received through receive coil 252 by wireless power 254. Wireless power 254 includes circuitry to receive wireless power and provide power to all of the other components in sensor unit 250. As such, wireless power 254 can include rectifiers, filters, regulators, power converters, or other components to provide power to components.

Sensor unit 250 further includes back-channel communications 256, which transmits and receives data through receive coil 252. For example, data may be received by demodulating a signal transmitted on the power, for example by amplitude or by frequency modulation. Data can be transmitted, for example, by modulating the load on wireless power 254 (which can be detected by reader unit 202).

Sensor unit 250 may include a microcontroller 258 coupled with memory 260. Memory 260 may include volatile (RAM) or non-volatile (ROM) memory for storage of data and programming instructions. Microcontroller 258 controls communications through back-channel communications as well as to receive sensor data from sensor block 262 in order to supply that sensor data through back-channel communications 256 to a reader unit 202.

As discussed above, sensor unit 250 does not include an internal power source and therefore is only powered when it is proximate to a reader unit 202. As such, when reader unit 202 is brought close to sensor unit 250 and provides wireless power to sensor unit 250, sensor unit 250 powers up and processor 218 executes instructions to activate sensors in sensor block 262 and receive data from sensors. The data is then transmitted through back-channel communications 256 to reader unit 202. When reader unit 202 is removed from the vicinity of sensor unit 250, sensor unit 250 becomes inactive.

FIGS. 2C and 2D illustrate circuit diagrams of certain features of reader unit 202 and sensor unit 250, respectively. As illustrated in FIG. 2C, power from power source 222 is provided to a power supply 276. Power supply 276 may include some or all of power converters 214, protections 212, rectifier 232, power regulators 230, and other components. Power supply 276 provides all of the voltage levels to all components of reader unit 202. Power supply 276 is also coupled to wireless power 206 to provide power to transmit coil 204.

Processor 218, coupled to memory 220, is coupled to user interface 234 and to communications block 272. Data can be transmitted to sensor unit 250 through communications 272 by modulating the output power in modulation block 208. Data can be received from sensor unit 250 through communications 272 by demodulating the output power that has been modulated by sensor unit 250. Data communications through wireless power 206 can use any protocol. Communications 272 can further provide data to interface 210. Interface 210 can be coupled to an antenna 274 for wireless communications, and may also include wired communication. As discussed above, any wired or wireless communications protocol may be used.

A circuit diagram illustrating features of sensor unit 250 according to some embodiments is illustrated in FIG. 2D. As is illustrated, wireless power is received from receive coil 252 into wireless power 254, which includes rectifiers, filters, and other electronics for receiving and processing power received from receive coil 252. The wireless power is supplied to a power distribution 276, which provides appropriate voltage levels for other components of sensor unit 250 as needed. Modulation/demodulation 256 demodulates data received through receive coil 252 and modulates data for transmission on receive coil 252. Communications 212 received data from and provides data to modulation/demodulation 256 and is coupled to processor 258. Consequently, processor 258 can send and retrieve data through receive coil 252. Processor 258 is also coupled to memory 260, which includes volatile and non-volatile memory for storage of programming instructions and data.

Processor 260 can also be coupled to driver 266, which provides voltages to power and operate sensors in sensor block 262. Data from the sensors in sensor block 262 can be received in analog-front-end (AFE) 264 for processing and digitizing. Data from AFE 264 is provided to processor 258. Processor 258 executes instructions to receive and process data from AFE 264 and to communicate the sensor data through communications 212. Processor 258 may also execute instructions to receive data, instructions, or programming updates from communications 212.

As is further illustrated in FIG. 2D, no internal power source is present. Therefore, sensor unit 250 only operates in the vicinity of a reader such as reader unit 202, which supplies the power to receive coil 252. Furthermore, reader unit 202 may provide instructions to and receive sensor data from sensor unit 250. Therefore, sensor unit 250 initiates and sensors in sensor block 262 are activated only in the presence of a reader such as reader unit 202 to provide power and receive sensor data.

FIG. 2E illustrates another depiction of the separation of functionality from a conventional sensor 100 to a wirelessly coupled reader unit 202 and sensor unit 250 system according to some embodiments. As is particularly pointed out in FIG. 2E, the sensor functions (sensor 108, an analog-front-end (AFE) 110, digital signal processor (DSP) 112, and driver 114) are incorporated into sensor unit 250 (sensor 262, AFE 264, driver 266 along with microcontroller 258). Sensor unit 250 is then equipped with wireless power 254 and communications 256 and coupled to receive coil 252. Similarly, the processing and power components of sensor system 100 are provided into reader unit 202 as described above and reader unit 202 is provided with a wireless power 206 and transmit coil 204. Reader unit 202 can be a handheld reader to read sensors that are applied to read data from a variety of situations. Alternatively, reader unit 202 may be a powered hub for wearable sensors unit 250, as described further below.

In some embodiments, reader unit 202 and passive sensor unit 250 can operate with large separations, for example about 30 cm, in order to provide power and communications capability with passive sensor unit 250. Reader unit 202 may communicate with other devices at a distance of up to about 30 m with standards such as Bluetooth or 6LoWPAN, for example. Consequently, as shown in FIG. 2E, reader unit 204 includes a dual range communications system (NFC/BLE as well as the shorter range communication through the wireless power transfer).

Sensor 108 of conventional sensor system 100 is included in sensor unit 250 as sensor 262. Sensor 262 can be any sensor or, in some cases, combination of sensors. For example, sensor 262 can be one or more of a moisture sensor, a gas sensor, an optical sensor, a stress or strain sensor, a vibration sensor, flow sensor, or any other sensor. Sensor 262 depends on the application of passive sensor 250 and can be tailored for particular uses.

As is further illustrated in FIG. 2E, transmit coil 204 and receive coil 252 can be printed coils. Circuitry, such as that discussed above in both reader unit 202 and sensor unit 250, along with any sensors 262 included in sensor unit 250, are embedded within the printed coils, or the printed coils may be included on circuit boards that include the circuitry and sensors.

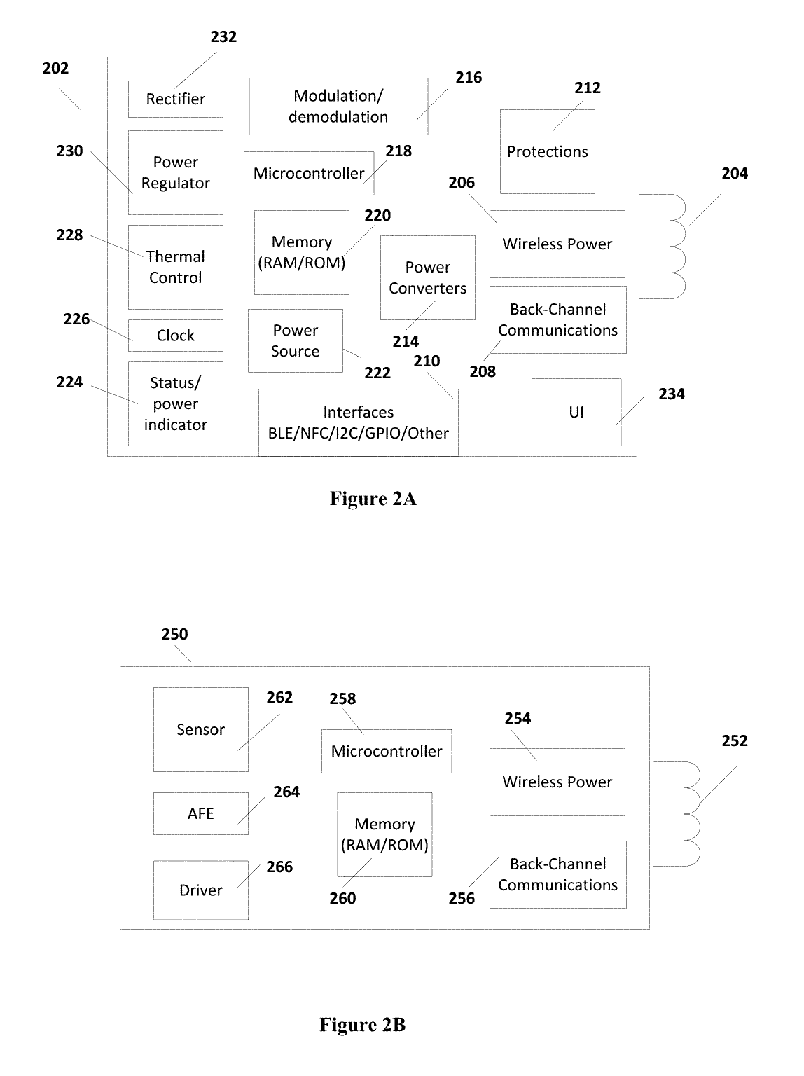

FIG. 3A illustrates a sensor unit 250 that is in communication with reader unit 202. As is illustrated, sensor unit 250 includes receive coil 252 and includes circuitry 304 incorporated with receive coil 252. Circuitry 304 includes sensors 262 as well as the supporting circuitry as is illustrated and discussed with reference to FIGS. 2A through 2E. As is further illustrated in FIG. 3A, reader unit 202 includes transmit coil 204 along with circuitry 302. Circuitry 302 includes all of the circuitry, including power supplies, described above with respect to FIGS. 2A through 2E to drive transmit coil 204. As described above, when sensor unit 250 is in proximity with reader unit 202, sensor unit 250 becomes active to provide data from sensors 262 to reader unit 202.

FIG. 3A illustrates a sensor unit 250 proximate to a reader unit 202. Reader unit 202 may be a handheld reader and sensor unit 250 can be any sensor placed in a location to monitor one or more environmental conditions. Reader unit 202 may also be considered a hub unit. A hub unit can communicated with one or more nearby sensor units 250 and provide the data to a third reading device through interface 210 as is illustrated in FIGS. 2A and 2C, for example.

FIG. 3B illustrates a reader unit 202 communicating with multiple passive sensor units 250. As indicated, reader unit 202 can communicate and power any number of passive sensor units 250, either individually or in groups. Furthermore, as illustrated in FIG. 3B, reader unit 202, as a wireless hub or a handheld reader, can be in communication with a separate device 306, which may be a tablet, smart phone, computer, or other device capable of exchanging data with reader unit 250.

Using reader units 202 as hub units, a complex network of sensor units 250 can be constructed. FIG. 3C illustrates device 306 communicating with any number of hub reader units 202, each of which are communicating with any number of passive sensors 250, to form a sensor network. Device 306 can be positioned to monitor several hub reader units 202 that, themselves, are in communication with one or more sensor units 250. In some cases, each of hub reader units 202 can monitor sensors units 250 and store data received from them until device 306 is in communication with the individual reader unit to download the data.

In one example, sensor units 250 can be wearable sensors. Wearable sensors can have receive coils 252 printed on a flexible substrate, which can be included into fabric materials. A hub reader unit 202 can also be worked into a wearable medium while being in contact with one or more of the wearable sensor units 250. In another example, one or more sensor units 250 can be applied in an environmental or medical application and monitored by a hub reader unit.

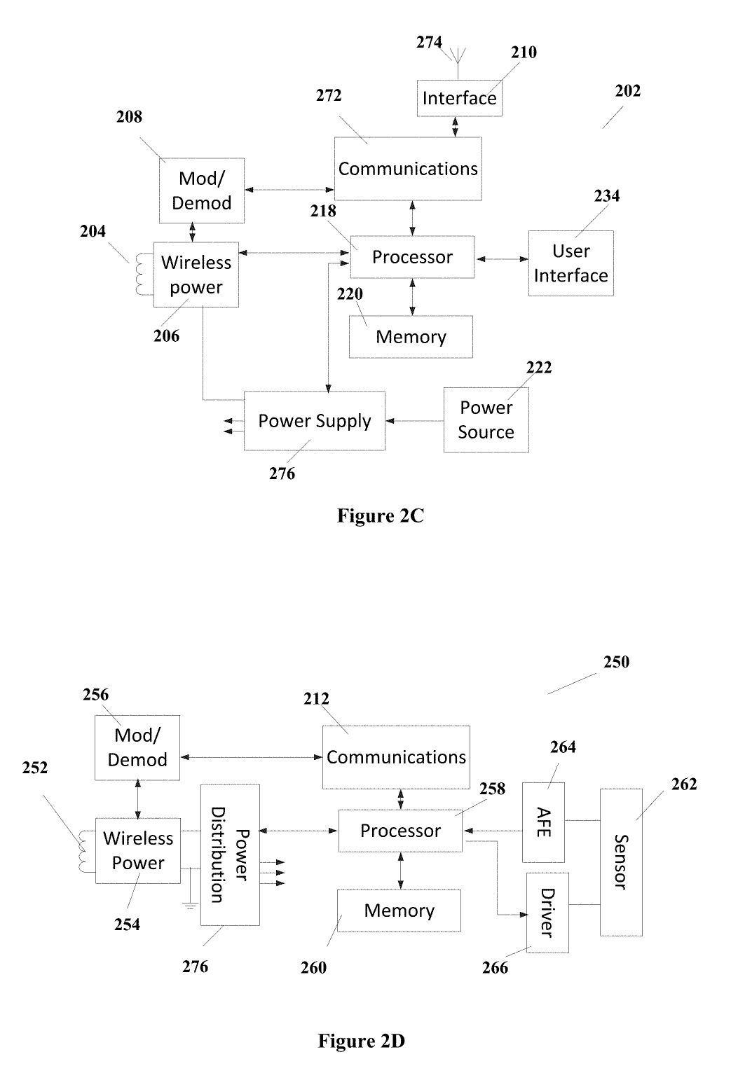

FIG. 4 further illustrates a reader unit 202 in communication with a passive sensor 250. As illustrated in FIG. 4, passive sensor unit 250 includes receive coil 252 with passive sensor circuit 304 mounted on receive coil 252. Similarly, reader unit 202 includes a transmit coil 204 with wireless hub circuit 302 mounted on transmit coil 204. As is further illustrated in FIG. 4, reader unit 202 may also include a sensor circuit 402.

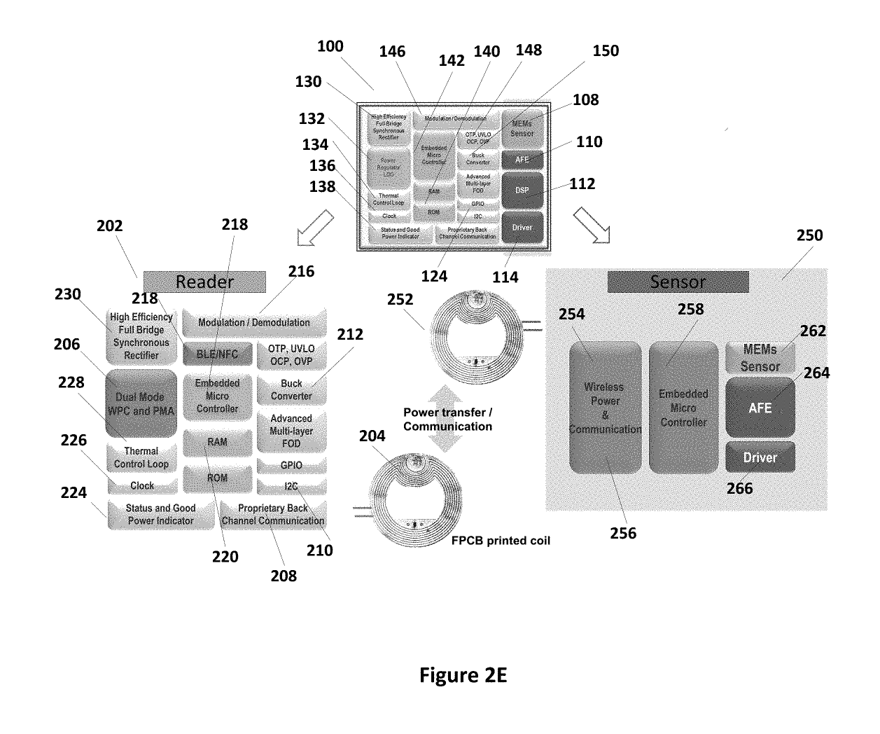

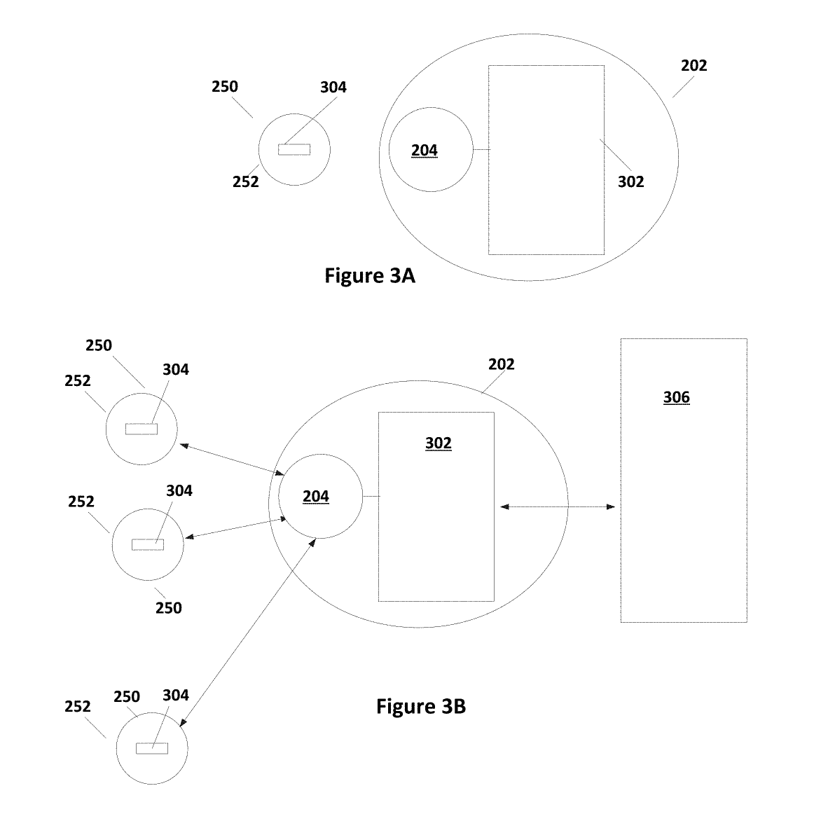

FIG. 5 also illustrates a passive sensor 250 in communication with a wireless hub reader unit 202. As is illustrated, sensor circuit 304 is incorporated on a circuit board in the center of receive coil 252. As is further shown in FIG. 5, passive sensor circuit 202 and receive coil 252 may be mounted on a backing, which may be flexible. Hub reader unit 202 may be provided in a sealed system that can be attached in the proximity of sensor unit 250. Data and wireless power are exchanged between sensor unit 250 and hub reader unit 202. FIG. 6 illustrates again communications between passive sensor 250 and wireless hub reader unit 202 while wireless hub reader unit 202 is further communicating wirelessly with another device. As is further illustrated, sensors 262 can be analog or digital sensors.

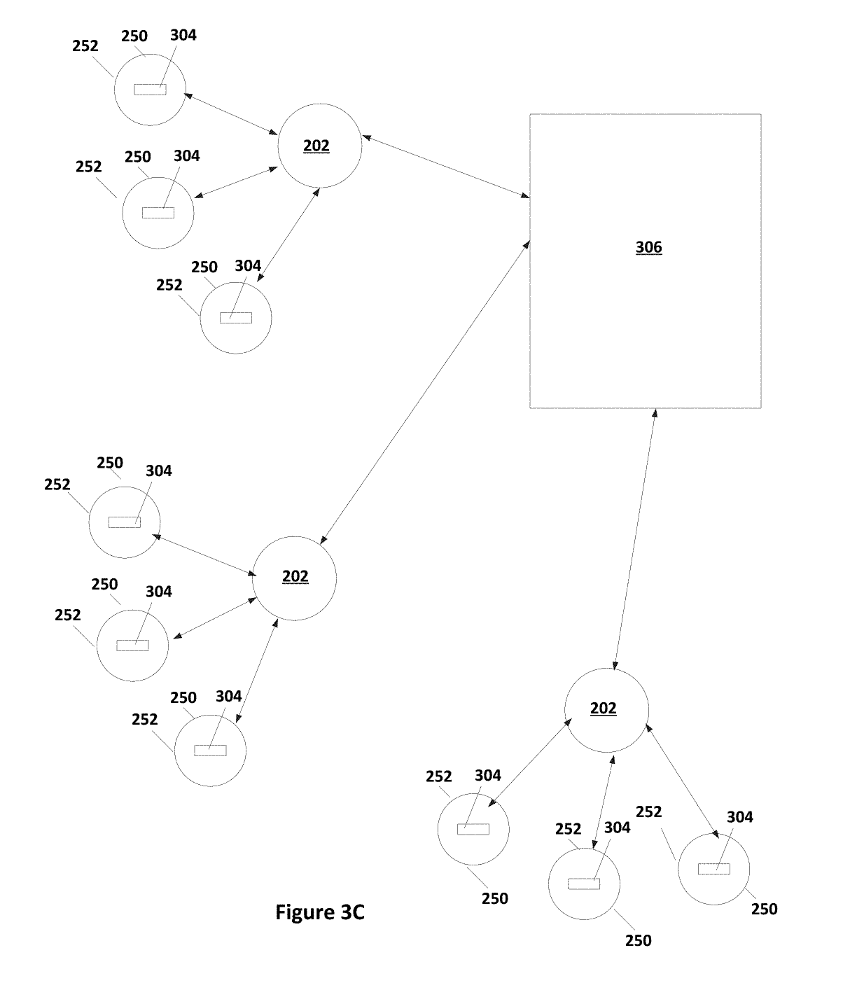

FIG. 7 illustrates a passive sensor unit 250 that includes a capacitor energy storage device 702 such as a supercap. Capacitor storage device 702 is charged wirelessly when passive sensor 302 is in the vicinity of a wireless hub 304 and allows passive sensor 302 to operate for a time following charging. Capacitor storage device 702 can provide interim power to sensor unit 250 for a sufficient time to shut down and store data when reader unit 202 is removed and no longer supplying power to sensor unit 250.

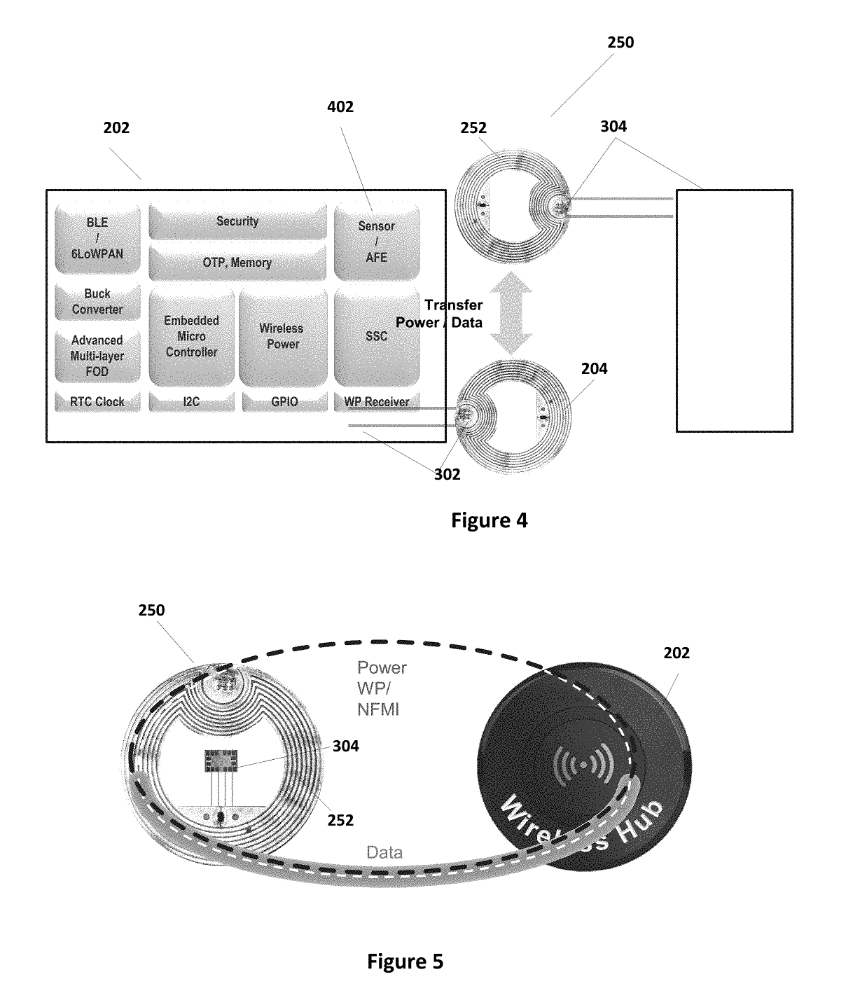

FIG. 8 further illustrates wireless hub reader unit 202. As discussed above, wireless hub read unit 202 can operate over short distances to supply power and communications with passive sensor 250. Further, wireless hub read unit 202 can operate over larger distances to communicate with other devices. As such, wireless hub reader unit 202 provides a power source, has offline data storage, includes routing with other devices such as mesh routing, and can provide a logging function. In some embodiments, wireless hub reader unit 202 may be a tablet or smart phone device.

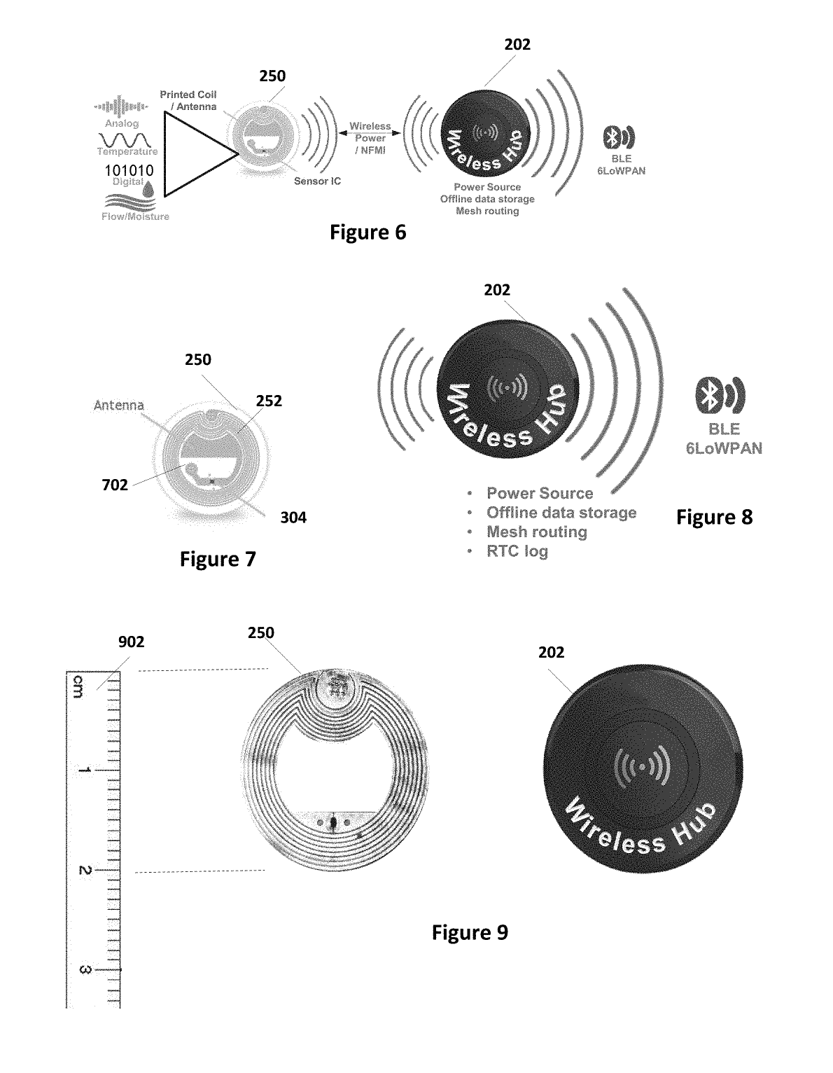

FIG. 9 illustrates common sizes of examples of passive sensor unit 250 and wireless hub reader unit 202. As illustrated by ruler 902, passive sensor 250 and wireless hub 202 can have about a 2 cm diameter. One skilled in the art will recognize that passive sensor 250 and wireless hub 202 can be any size larger or smaller than a 2 cm diameter and can have any other shape, for example rectangular or oval. The example illustrated in FIG. 9 is only provided for illustration.

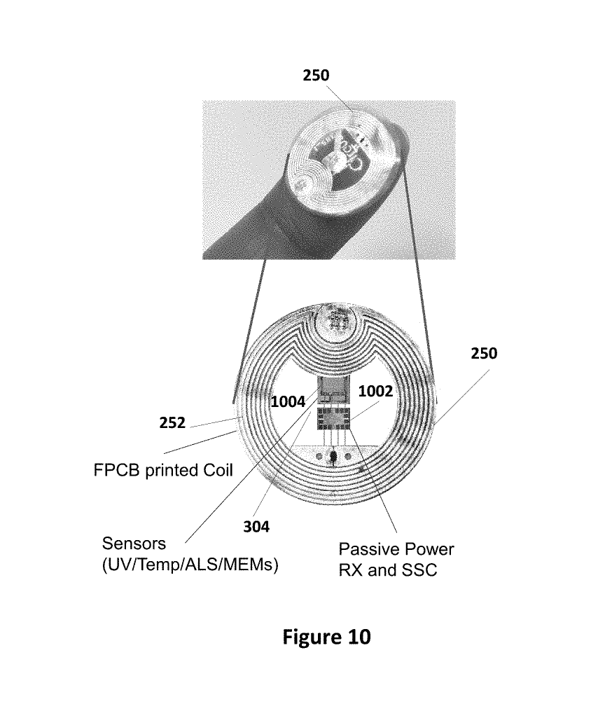

FIG. 10 further illustrates the size of a passive sensor unit 250. As shown in FIG. 10, passive sensor circuit 304 can be split into a power unit 1002 and a sensor unit 1004. Receive coil 252, power unit 1002, and sensor unit 1004 may be deposited on a flexible backing for ease of mounting for a particular application.

As discussed above, sensor unit 250 includes circuitry 304 for signal conditioning and wireless power reception, which can be provided on a single circuit board or multiple circuit boards embedded with receive coil 252. Sensor unit 250 does not contain a battery and is actively powered by a reader unit 202. When the sensor unit 250 is powered, the sensors included in sensor unit 250 takes measurements and uses in-band communication to communicate with reader unit 202. Reader unit 202 includes a wireless power transmitter, a transceiver to send and receive in-band communications, and contains a power supply (battery or other source of power) to power the system and supply power to the wireless transmitter. Reader unit 202 may also include additional components, including flash memory to store received messages and a wireless or wired communication system to communicate information received from the sensor cube to a computer, mobile phone, or other device.

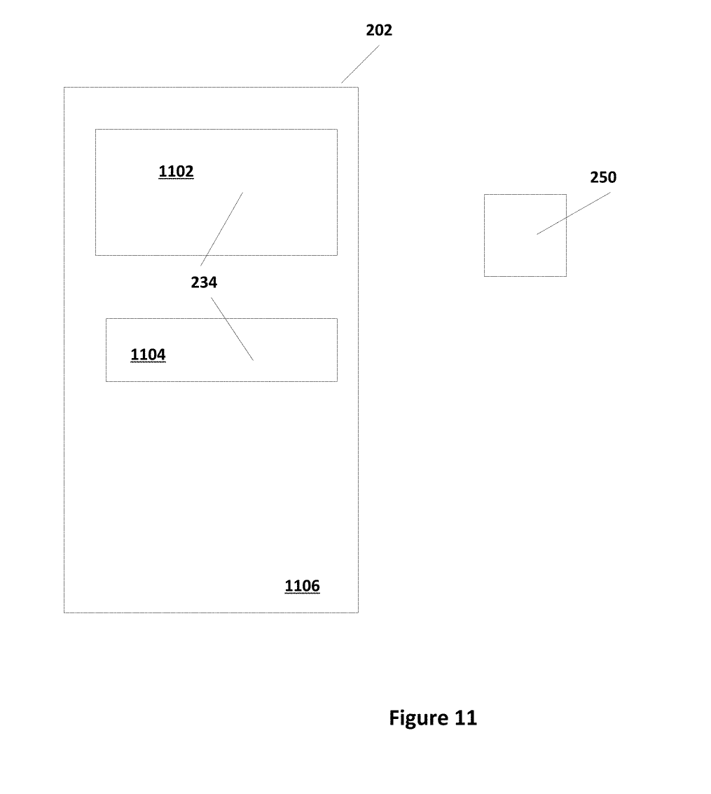

FIG. 11 illustrates an example use with a reader unit 202, which displays a UI 234 that can include a video screen (or touchscreen) 1102 and one or more user input areas 1104. Handheld reader unit 202 can communicate with one or more sensor units 250. As is illustrated in FIG. 11, sensor units 250 can have any form factor with a receive coil 252 and electronics 304 to receive wireless power, drive sensors in the electronics 304, and communicating data to handheld reader unit 202. In some embodiments, reader unit 202 as illustrated in FIG. 11 can be a PDA or smart phone adapted for wireless power transfer and for backchannel communications with sensor unit 250. The circuitry 302 and transmit coil 204 are enclosed within a case 1104, which allows easy use of reader unit 202.

Sensor 262 of sensor unit 250 can be a flow sensor, a thermopile, a temperature sensor, an optical sensor, or any other type of sensor. Wireless power transmitted from reader unit 202 to sensor unit 250 can be magnetic resonance, magnetic induction, or radiofrequency. Range (the distance between reader unit 202 and sensor unit 250) can be from contact or near-contact to a significant distance, depending on application, power requirements, and wireless power system implemented.

As is discussed above, sensor unit 250 has minimal functionality, and can be disposable—all of the power and more complicated hardware is in reader unit 202. In addition, sensor unit 250 does not include a battery and may have limited capabilities, sensor unit 250 can be designed for high-temperature, low-temperature applications, or other applications in adverse environments where a battery might not work.

In some embodiments, sensor unit 250 may be a disposable unit and and/or may be embedded within a component of a system, which itself may be disposable. In some medical applications, sensor unit 250 may be implanted or may be wearable in some fashion.

Passive sensor units 250 can, for example, be formed on a continuous tape of sensors that then can be attached to items of clothing, materials for construction, in packaging to track shipping conditions, or used in other areas where sensing is useful. In some embodiments, passive sensor units 250 can be incorporated within any packaging or other system.

As such, sensor systems as illustrated in the systems described above have a large number of applications. For example, passive sensor units 250 can be used in medical sensors where the passive sensor unit 250 is disposable and a reader unit 202, whether operating as a hub or operating as a mobile unit, is used to periodically read passive sensor unit 250.

Several system use examples for systems involving reader unit 202 and sensor unit 250 according to embodiments of the invention as described above are provided below. These example use cases are not exhaustive and one skilled in the art will realize other uses for systems according to these embodiments. These examples are provided for instruction only and are not intended to be limiting.

Smart clothing can be devised for various applications. For example, smart diapers can include sensor units 250 with moisture sensing sensors. Smart clothes can be equipped with sensors to monitor the activity of the wearer, including physical activity with kinematic sensors, temperature, moisture, heart rate, oxygen levels, or other attributes. In some applications, smart clothes can be equipped with gas sensors, radiation sensors, or other environmental sensors to monitor for dangerous environmental conditions.

Smart clothing, for example, can have one or more sensor units 250 with a perspiration or heartbeat or chemical sensors built in to monitor exercise. Reader unit 202 can act as a hub and be clipped on to the collar or other part of the clothing to activate and monitor the built-in sensor units 250. Reader unit 250 can include sufficient flash memory in memory 220 to store the measurement data so that the person can work out without carrying a cell phone or otherwise being within range of a device in communication with reader unit 202. In addition, reader unit 202 can be removed after exercise and attached to a different piece of smart clothing while the first piece of clothing is in the laundry and thereby interact with a different set of sensor units 250.

Sensor units 250 can also be used for food package monitoring, transport tracking, component tracking, and other applications. For example, a sensor unit 250 where sensor 262 includes a temperature sensor can be placed on or in a piece of meat or other food. When the food is placed in an oven, a reader unit 202 remaining outside of the oven can provide real-time information on the food temperature to a cook, even when placed in a microwave oven. Such a sensor unit 250 can be a one-time use sensor.

Another potential use can be for filter monitoring, monitoring the flow and chemical composition of the fluid or gas being filtered in the filter and thereby determining when the filter needs changing. Sensor units according to the present invention can be used to monitor building structures for moisture, structural parameters (stress and strain conditions of various components), detection of various gasses, and other conditions. Such construction monitoring can be useful in marine or aerospace construction as well as in building structures and can be used to periodically monitor various aspects of ships, boats, aircraft, or spacecraft.

In another example system, a sensor unit 250 can be built into an IV drip tube. Reader unit 202 can, in some examples, be snapped onto the tube of the IV to provide real-time measurement (and potentially management) of IV flow. When the IV is no longer needed, reader unit 202 can be snapped off and attached to another system, while the IV tube with sensor unit 250 can be discarded.

In another example use, sensor units 250 where sensors 262 include moisture sensors can be placed into a field where soil moisture is to be measured (e.g., an agricultural field). Reader unit 202 can be a drone equipped with GPS. Reader unit 202 can then be sent to each sensor in turn to obtain moisture measurements from each sensor. The drone with reader unit 202 could land on (or hover near) each sensor unit 250, wirelessly provide power to that sensor unit 250, collect the data from that sensor unit 250, and then fly to the next sensor unit 250.

The above detailed description is provided to illustrate specific embodiments of the present invention and is not intended to be limiting. Numerous variations and modifications within the scope of the present invention are possible. The present invention is set forth in the following claims.

What is claimed is:

1. A sensor unit, comprising:
a sensor;
a receive coil;
a circuit coupled to the sensor, the circuit configured to receive sensor data from the sensor; and
a wireless power circuit configured to receive power from the receive coil and configured to provide power to the circuit,
wherein the sensor unit is unpowered when power is absent from the receive coil.

2. The sensor unit of claim 1, wherein the circuit comprises:
a front-end circuit configured to receive data from the sensor;
a processor coupled to receive sensor data from the front-end circuit; and
a communications circuit coupled to the processor to receive sensor data for transmission, the communications circuit coupled to the wireless power circuit to communicate the sensor data through the wireless power circuit.

3. The sensor unit of claim 2, wherein the communications circuit receives messages transmitted through the wireless power circuit and provides the messages to the processor.

4. The sensor unit of claim 2, wherein the wireless power circuit comprises:
a wireless power receiver coupled to the receive coil;
a modulator and demodulator circuit configured to modulate and demodulate data transmitted from or sent to the receive coil; and
a power distribution circuit coupled to receive power from the wireless power receive and provide power to the sensor unit.

5. The sensor unit of claim 2, wherein the circuit includes a driver coupled to provide power to the sensor.

6. The sensor unit of claim 1, wherein the wireless power and communications circuit receives power and communicates data through the wireless power receiver coil.

7. The sensor unit of claim 2, wherein power is supplied to the sensor unit by a reader unit and wherein the reader unit receives the sensor data from the sensor unit.

8. A reader unit, comprising:
a power source;
a transmit coil;
a wireless power transmitter configured to receive power from the power source and configured to drive power to the transmit coil;
a communications circuit coupled to the wireless power transmitter, the communications circuit coupled to the wireless power transmitter to transmit and receive data; and
a processor coupled to the communications circuit, the processor coupled to send and receive data through the wireless power transmitter.

9. The reader unit of claim 8, further including a user interface coupled to the processor.

10. The reader unit of claim 8, wherein the wireless power transmitter provides power to a sensor unit and receives sensor data from the sensor unit.

11. The reader of claim 8, wherein the communications circuit is coupled to an interface circuit, the interface circuit coupled to communicate with an external device.

12. The reader of claim 11, wherein the interface circuit communicates wirelessly with the external device.

13. A sensor system, comprising:
one or more passive sensor units, each of the one or more passive sensors configured to receive wireless power from a receiver coil and communicate data through the receiver coil; and
one or more reader units, each of the one or more receiver units configured to supply power and communicate with a set of the one or more passive sensor units.

14. The system of claim 13, further including an external device in communications with the one or more read units.

15. The system of claim 13, wherein the one or more reader units are hub units.

16. The system of claim 13, wherein the one or more reader units are handheld.

17. The system of claim 13, wherein the one or more passive sensor units are embedded within disposable components.

18. The system of claim 17, wherein the disposable component is an IV tube.

19. The system of claim 13, wherein the one or more passive sensor units are wearable units.

20. The system of claim 13, wherein the one or more passive sensor units are embedded within a product.
